(19) United States
(12) Patent Application Publication
(10) Pub. No.: US 2023/0366481 A1
(43) Pub. Date: Nov. 16, 2023

(54) Switch Valve With A Stepping Motor

(71) Applicant: ECO Holding 1 GmbH, Marktheidenfeld (DE)

(72) Inventors: Dietmar Schulze, Münzenberg (DE); Alexander Schober, Würzburg (DE); Alexander Mudra, Görlitz (DE)

(73) Assignee: ECO Holding 1 GmbH, Marktheidenfeld (DE)

(21) Appl. No.: 18/030,092

(22) PCT Filed: Sep. 28, 2021
(86) PCT No.: PCT/EP2021/076669

§ 371 Date: Apr. 4, 2023

(30) Foreign Application Priority Data
Oct. 5, 2020 (DE) 102020125944.1

(51) Int. Cl. F16K 31/04; F16K 31/528; F16F 9/34; F16F 9/46

(52) U.S. Cl. CPC F16K 31/047; F16F 9/34; F16F 9/461; F16K 31/528; F16F 2222/126; F16F 2228/066; F16F 2230/18

(57) ABSTRACT

A switch valve is disclosed including a stepping motor and a housing configured to receive a stepping motor, itself operatively connected to an actuating element which is configured to position a valve body that is arranged in the housing so as to perform a translatory movement of the switch valve. The coupling element is configured to convert a rotational movement of the stepping motor into a translational movement of the actuating element. A motor shaft of the stepping motor is arranged coaxially with the actuating element and the coupling element. The motor shaft and the actuating element are configured to engage in the coupling element.

### CROSS REFERENCE TO RELATED APPLICATIONS

This application is a national phase application of International Application No.: PCT/EP2021/076669, filed on Sep. 28, 2021, and further claims priority to German Patent Application 102020125944.1, filed Oct. 5, 2020, the content of the aforementioned applications incorporated herein by reference.

### BACKGROUND OF THE INVENTION

### Field of the Invention

The present invention relates to a switch valve with a stepping motor.

### Description of Related Art

Switch valves with stepping motors are commonly known. These switch valves are preferably used to control air springs in automotive engineering.

A switch valve for an air spring is known from the published patent application DE 10 2018 111 003 A1, which comprises a stepping motor in order that a valve passage of the switch valve can be actuated steplessly or in at least more than three steps. The stepping motor is configured to generate an operating displacement in the longitudinal direction, so that it is configured in the form of a linear motor.

A switch valve for an air spring is known from the patent specification EP 3 416 837 B1, which comprises a stepping motor, whereby the stepping motor is integrated into the switch valve. With the help of the disclosed switch valve, a stair-stepped stroke course of a valve body of the switch valve can be realised, whereby a stepless opening of the switch valve is not possible.

The patent specifications DE 100 25 749 C1 and DE 100 25 753 C2 disclose a switch valve for an air spring, wherein a valve body of the switch valve is infinitely adjustable, but a stepping motor provided is in the form of a linear motor.

The patent specification EP 2 765 325 B1 also discloses a switch valve with a stepping motor, wherein the stepping motor comprises a gear for translating its rotatory movement into a translatory movement necessary for the axial displacement of a valve body of the switch valve, which gear is usually designed in the form of a toothed gear.

### BRIEF SUMMARY OF THE INVENTION

It is an object of the invention to provide switch valve with a stepping motor, which in particular is configured to be space-saving and cost-optimised.

A switch valve with a stepping motor is proposed, with a housing which is configured to accommodate a stepping motor. The stepping motor is operatively connected to an actuating element. The actuating element is configured for positioning a valve body, wherein the valve body is arranged in the housing so as to perform a translatory movement of the switch valve, and wherein a coupling element is arranged between the stepping motor and the actuating element.

According to the invention, the coupling element is configured to translate a rotational movement of the stepping motor into a translational movement of the actuating element, wherein a motor shaft of the stepping motor is arranged coaxially with the actuating element and the coupling element. A stroke course is also configured as a function of a rotation angle of the coupling element. The stroke course can thus be adapted to the different requirements during operation.

Due to the coaxial arrangement of the motor shaft, the actuating element and the coupling element, a switch valve extending in the axial direction can be realised, which is optimized for installation space at least in the radial direction. With an appropriate arrangement of the motor shaft, the actuating element and the coupling element, e.g. by an arrangement of the coupling element comprising the actuating element and/or the motor shaft, and/or by an engagement of the motor shaft and/or the actuating element in the coupling element, a switch valve which is further optimised in terms of installation space can be brought about. The coaxial arrangement of the motor shaft, the coupling element and the actuating element, and in particular the configuration of the coupling element for translating the rotational movement of the motor shaft into a translational movement of the actuating element, also leads to a cost-reduced switch valve, since a complex gearbox can be dispensed with.

The coupling element is configured to be rotatable with the motor shaft, whereby there is a cost-effective press fit between the coupling element and the motor shaft for the transmission of the torque. However, the torque transmission can alternatively be configured as a form fit and/or material joint.

The actuating element can perform an axial movement with the aid of a force-guide in the coupling element, which is preferably realised with the aid of a groove formed in the coupling element, during a rotation of the coupling element, wherein the groove is configured in a spiral shape advantageously for translating the rotational movement into the translational or axial movement. However, the coupling element could also be configured to engage in an advantageously spiral-shaped groove formed in the actuating element. As a further alternative, it is also possible to configure the coupling element to be non-rotatable with the actuating element, whereby a force-guide of a corresponding contour is provided on the motor shaft. In this way, for example, a continuously differentiable stroke course of the valve body can be advantageously brought about.

The valve body is configured to change the chamber volume of an air spring so that a cost-effective and space-optimised air spring can be provided, as it is required in particular in automotive engineering.

The actuating element comprises an anti-rotation device to secure the adjustment of the valve body. In other words, the exclusively axial or translatory movement of the actuating element is secured. Thus, the valve body can be adjusted in real time.

A further secured adjustment of the actuating element is realised by bearing the actuating element in the housing in an axially displaceable manner with the help of a bearing element. Advantageously, the bearing element is configured as a plain bearing, which can be designed in the form of a sleeve in a cost-effective and space-optimised manner.

The stroke course is preferably configured to be freely selectable depending on a rotation angle of the coupling element. This can be easily realised by freely selecting a gradient of the groove, corresponding to a desired stroke course of the valve body, in dependence on the angle of rotation.

In particular, the stroke course can have areas without inclination in the end positions or a reversal of the direction of inclination shortly before the end positions. The latching function is thus realised in the contour of the coupling element’s groove and without an additional component. The latching function enables the desired position to be held securely even without power supply to the actuator and despite external influences (e.g. such as accelerations) acting on the valve.

For simplified assembly, which has an effect on the costs, the coupling element has an entry groove which is configured to open into the groove. The entry groove is preferably configured at the end of the coupling element facing away from the stepping motor and extends advantageously in the axial direction of the coupling element. In this way, the actuating element can be easily inserted into the coupling element and a guide element configured to guide the actuating element in the coupling element or vice versa can be positioned.

### BRIEF DESCRIPTION OF THE SEVERAL VIEWS OF THE DRAWINGS

Further advantages, features, and details of the various embodiments of this disclosure will become apparent from the ensuing description of a preferred exemplary embodiment and with the aid of the drawings. The features and combinations of features recited below in the description, as well as the features and feature combination shown after that in the drawing description or in the drawings alone, may be used not only in the particular combination recited, but also in other combinations on their own, without departing from the scope of the disclosure.

Further advantages can be derived from the following description of the drawings. The drawings show examples of embodiments of the invention. The drawings, the description and the claims contain numerous features in combination. The skilled person will expediently also consider the features individually and combine them to form useful further combinations.

An advantageous embodiment of the present invention is set out below with reference to the accompanying figures, wherein:

FIG. 1 depicts in a longitudinal section a switch valve according to the invention for an air spring,

FIG. 2 depicts in a perspective view of the switch valve according to FIG. 1 without housing,

FIG. 3 depicts in a side view of the switch valve according to FIG. 2 in a section,

FIG. 4 depicts in a perspective view, a coupling element of the switch valve according to the invention, and

FIG. 5 depicts in a rotation angle-stroke diagram a stroke course of the switch valve according to the invention.

### DETAILED DESCRIPTION OF THE INVENTION

As used throughout the present disclosure, unless specifically stated otherwise, the term “or” encompasses all possible combinations, except where infeasible. For example, the expression “A or B” shall mean A alone, B alone, or A and B together. If it is stated that a component includes “A, B, or C”, then, unless specifically stated otherwise or infeasible, the component may include A, or B, or C, or A and B, or A and C, or B and C, or A and B and C. Expressions such as “at least one of” do not necessarily modify an entirety of the following list and do not necessarily modify each member of the list, such that “at least one of A, B, and C” should be understood as including only one of A, only one of B, only one of C, or any combination of A, B, and C.

In the figures, identical or similar components are numbered with the same reference signs. The figures only show examples and are not to be understood as limiting.

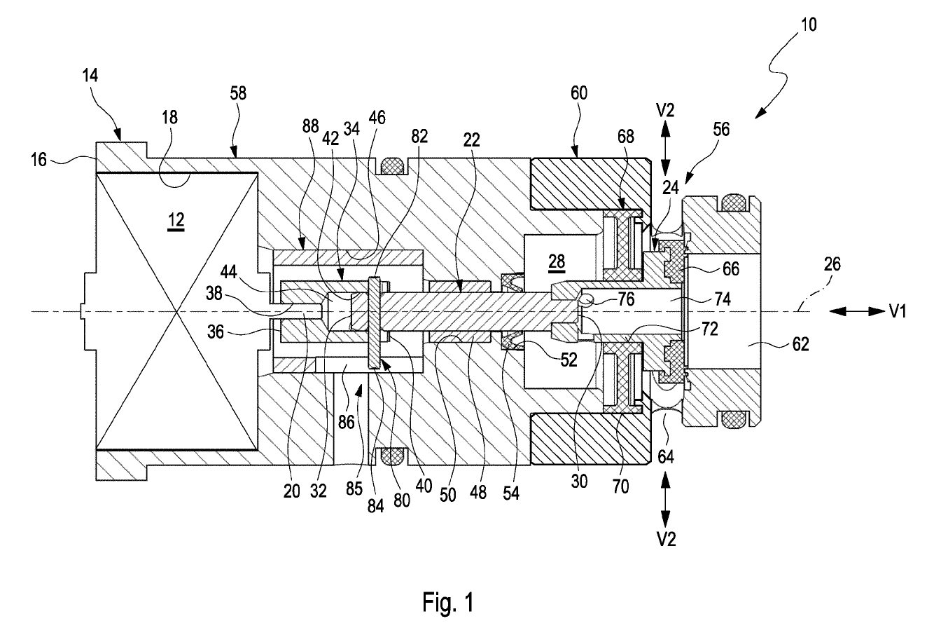

FIG. 1 illustrates a longitudinal section of a switch valve 10 according to the invention with a stepping motor 12, wherein the switch valve 10 in this embodiment is configured for an air spring, which is not shown in more detail, for controlling the chamber volume of the air spring.

The switch valve 10 comprises a housing 14 which is configured to receive the stepping motor 12. For receiving the stepping motor 12, the housing 14 is configured with a first receiving opening 18 at its first end 16. The stepping motor 12, which has, for example, a rated voltage of 5 V, a rated current requirement of 0.45 A and a step angle of 7.5°, comprises a motor shaft 20 which faces away from the first end 16 and is in operative connection with an actuating element 22 of the switch valve 10. The actuating element 22 is configured to change a stroke H of the switch valve 10, the change in the stroke H being accompanied by a change in the effective chamber volume of the air spring. In the present embodiment, the air spring comprises two chamber volumes V1, V2. The open switch valve 10 connects the two chamber volumes V1 and V2 to form an effective chamber volume V1+V2. If the switch valve 10 is closed, the two volumes V1 and V2 are separated so that only the first chamber volume V1 is effective.

The actuating element 22 is also operatively connected to a valve body 24 of the switch valve 10, which is also adjusted due to its fixed connection to the actuating element 22 in the present embodiment. The actuating element 22 is configured for an axial movement possible in the direction of a longitudinal axis 26 of the switch valve 10. If the actuating element 22 is moved with the help of the stepping motor 12, the valve body 24 also moves axially, i.e. translationally, in the direction of the longitudinal axis 26, wherein the valve body 24 is also movably received in the housing 14 in a second receiving opening 28 of the housing 14, which faces away from the first receiving opening 18. Thus, the stroke H of the switch valve 10 is due to the axial movement of the valve body 24, which is fixedly connected to the actuating element 22. Since no transmission of the axial movements of the actuating element 22 and/or the valve body 24 are configured, the stroke H of the switch valve 10 corresponds to the axial movement of the actuating element 22 and the axial movement of the valve body 24.

If it is necessary to compensate for length tolerances of individual components between actuating element 22 and valve body 24, a preloaded spring can be integrated in an embodiment of the switch valve 10 not shown. This ensures that the end position (defined by a number of motor steps or targeted travel to the end of the sliding guide) is reached safely without risking excessive forces in the valve seat or excessive torque for the motor (step loss) in the event of unfavourable length tolerances.

The longitudinal axis 26 of the switch valve 10 corresponds to an axis of rotation of the motor shaft 20, and it corresponds to a longitudinal axis of the actuating element 22, the coupling element 34 and the valve body 24, as they are configured coaxially with each other.

The actuating element 22 is configured in the form of a tappet and is firmly connected to the valve body 24 at its first element end 30, which faces the valve body 24. At its second element end 32, which faces away from the first element end 30, it is operatively connected to the motor shaft 20 by means of a coupling element 34.

The coupling element 34 is formed as a hollow cylinder and comprises a first element opening 38 at its first element end 36 facing the motor shaft 20, which is configured to achieve an interference fit with the motor shaft 20. Alternatively, the torque transmission between the motor shaft 20 and the coupling element 34 can be configured as a form fit and/or material joint. At its second element end 40, which faces away from the first element end 36, it comprises a second element opening 42, which is configured to receive the actuating element 22, whereby an operative connection of the actuating element 22 with the motor shaft 20 is realised. The two element openings 38, 42 are configured adjacent to each other, whereby a cavity 44 is formed which completely penetrates the coupling element 34 in the axial direction. This has proven to be simple and inexpensive in terms of manufacturing. However, complete penetration is not mandatory.

Between the coupling element 34, which is accommodated in the housing 14 in a third receiving opening 46, and the valve body 34, a bearing element 48 is arranged in a fourth receiving opening 50 of the housing 14, which is configured for the bearing and secured axial guidance of the actuating element 22. The bearing element 48 is in the form of a sleeve for creating a sliding bearing. A first sealing element 54 of the switch valve 10, which comprises the actuating element 22, can be arranged between the bearing element 48 and the valve body 24 in a fifth receiving opening 52 of the housing 14.

The first sealing element 54 is arranged to securely seal a working chamber 56 formed in the housing 14 of the switch valve 10, so that no lubricant used for the sliding bearing of the actuating element 22 can enter the working chamber 56.

Further, the volumes V1 and V2 can be reliably sealed to the outside by the seal 54. Alternatively, a sealed lead-out of the motor cables from the valve housing 14 can be provided, in which case the same pressure is present in the receiving opening 46 and in the stepping motor 12 as in V1.

The housing 14 is configured in two parts for cost-effective and simplified assembly of the switch valve 10. A first housing part 58 of the housing 14 serves to receive the stepping motor 12, the coupling element 34, the bearing element 48 and the first sealing element 54 and, of course, the actuating element 22. The valve body 24 is enclosed both by the first housing part 58 and by a second housing part 60 of the housing 14, which is formed predominantly adjacent to the first housing part 58, wherein in the region of the second receiving opening 28 the second housing part 60 is configured to enclose the first housing part 58. In other words, the second housing part 60 is fitted onto the first housing part 58 in the region of the second receiving opening 28.

The second housing part 60 is configured for connection to the air spring and comprises a first chamber access 62 for the first volume V1 and a second chamber access 64 for the second volume V2.

In the position of the valve body 24 shown in FIG. 1, the two chamber accesses 62, 64 are separated from each other. In order to securely separate the two chamber accesses 62, 64, the valve body 24 comprises a second sealing element 66 at its end facing the first chamber access 62, which ensures a tight separation of the two chamber accesses 62, 64 from each other and prevents an overflow of working medium, in this embodiment air.

A third sealing element 68 is arranged in the switch valve 10 between the second receiving opening 28 and the second sealing element 66, the third sealing element 68 separates the working chamber 56 from the second receiving opening 28 in a substantially sealed manner. The third sealing element 68 is in the form of a diaphragm, whereby this diaphragm can change depending on a pressure ratio of pressures in the chambers of the air spring. In the present embodiment example, the diaphragm 68, which is annular in shape, is firmly received at its outer circumference 70 between the first housing part 58 and the second housing part 50. At its inner circumference 72, it is firmly connected to the valve body 24, whereby a change in position of the inner circumference 72 is realised when the position of the valve body 24 changes.

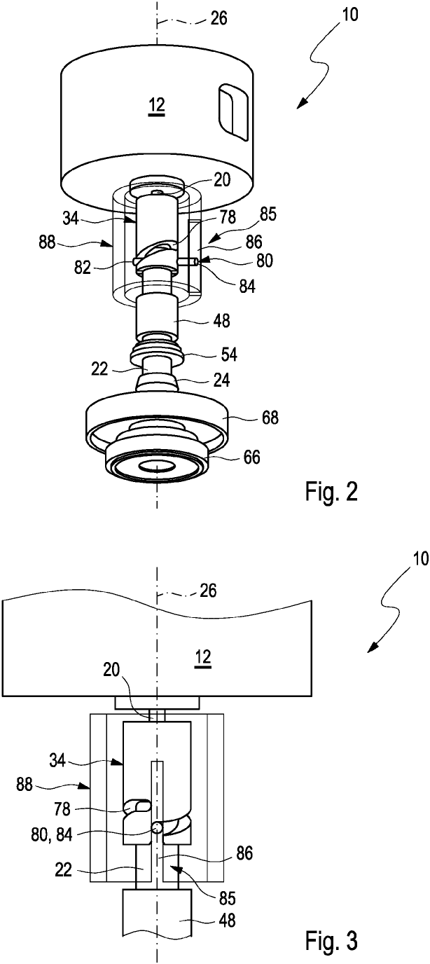

In FIG. 2, the switch valve 10 according to the invention is shown without the housing 14 for further illustration.

For example, when the actuating element 22 is moved in the direction of the actuator 12 by rotation of the actuator 12, the valve body 24 is moved in the same direction due to its fixed connection to the actuating element 22, and the valve body 24 and the second sealing element 66 allow a flow from the first chamber access 62 into the second chamber access 64 and vice versa.

In order to achieve pressure equalisation in the second receiving opening 28, the valve body 24 is configured to comprise a body cavity 74 which, starting from a jacket opening 76, is connected to the first chamber access 62 so that flow can pass through it.

The coupling element 34 is configured to convert a rotational movement of the stepping motor 12 into a translational movement of the actuating element 22. This means, in other words, that the rotational movement of the motor shaft 20 in this embodiment example is converted into an axial movement of the actuating element 22, respectively a translatory movement of the actuating element 22, along the longitudinal axis 26. For this purpose, the coupling element 34 comprises a spiral groove 78 in the form of a sliding guide in which the actuating element 22 is configured to engage.

In the shown embodiment example, the groove 78 in the sleeve-shaped coupling element 34 extends completely through the actuating element 22 in the radial direction and thus completely penetrates a wall of the coupling element 34 in the radial direction, which enables secure guidance of the actuating element 22 in the groove 78. Alternatively, the groove 78 can also only partially penetrate the coupling element 34. For secure guidance, the actuating element 22 comprises a guide element 80 which extends transversely to its longitudinal extension, advantageously in the form of a pin which engages in the groove 78. Thus, the coupling element 34, which is firmly connected to the motor shaft 20, performs a rotational movement when the motor shaft 20 rotates, whereby the actuating element 22, which is accommodated in the coupling element 34 so as to be axially movable, performs a forced movement in the axial direction with the help of the pin 80.

The actuating element 22 comprises an anti-rotation device 85, as can be seen in particular in FIG. 3. The pin 80 is configured to extend transversely through the actuating element 22, wherein at its second pin end 84 facing away from the first pin end 82, which is accommodated in the sliding guide 78, it is arranged to engage in a securing groove 86 of the anti-rotation device 85, which is configured to enclose the coupling element 34 in a securing sleeve 88 of the anti-rotation device 85. The securing groove 86 is configured to extend in the direction of the longitudinal axis 26.

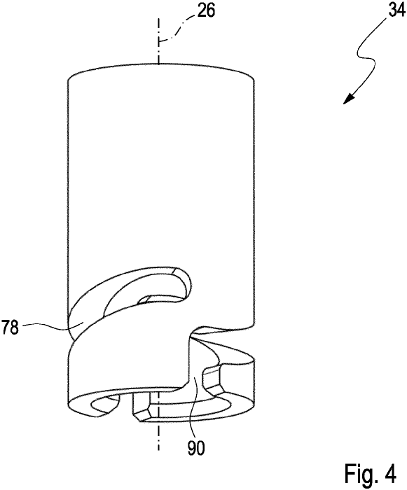

FIG. 4 shows a perspective illustration of the coupling element 34. An entry groove 90 is formed at its sleeve end facing away from the stepper motor 12, the entry groove 90 extends in the axial direction, i.e. in the direction of the longitudinal axis 26, and opens into the sliding guide 78. This entry groove 90 is provided for receiving the pin 80 in the assembly process of the switch valve 10. The actuating element 22 is inserted into the coupling element 34 up to the pin 80, and finally the pin 80 is positioned in the sliding guide 78 via the entry groove 90.

In an embodiment of the switch valve 10 according to the invention, which is not shown in greater detail, the switch valve 10 comprises so-called latching functions in its end positions.

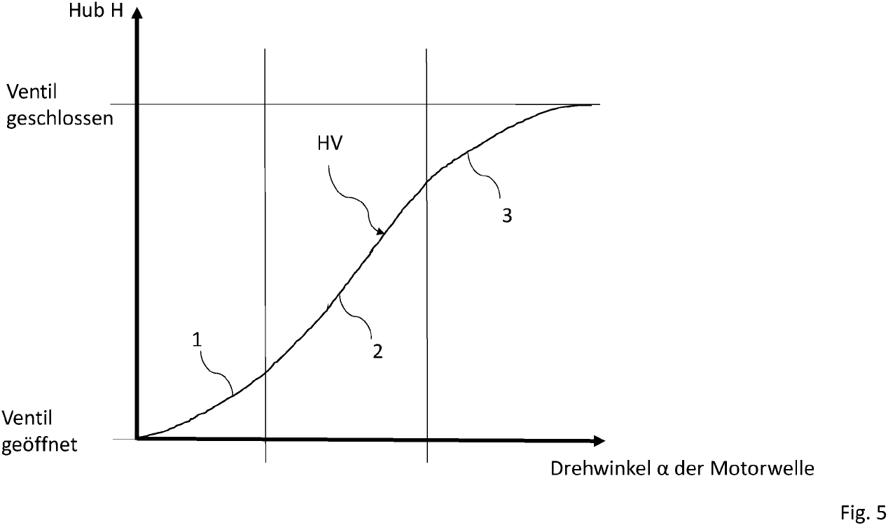

The rotation angle-stroke diagram shown in FIG. 5 illustrates a stroke course HV of the stroke H of the actuating element 22 of the switch valve 10 according to the invention, wherein the stroke H of the actuating element 22 is plotted over an angle of rotation α of the motor shaft 20 and thus of the coupling element 34. The stroke course HV results from a contour of the groove 78. In other words, the stroke course HV is set as a function of a gradient of the groove 78, which is dependent on the angle of rotation.

According to the invention, the groove 78 in the coupling element 34 can comprise a varying gradient depending on the angle, so that the stroke course can be adapted to the different requirements during operation by providing areas with different groove gradients. Thus, at a constant speed of the drive, stroke ranges of the actuating element 22 with high speed and low feed force (range 2) and ranges with low speed and high feed force (ranges 1 and 3) can be generated. Consequently, the actuating element 22 can cover a large stroke H in a short time and also achieve a high closing force in the end positions for reliable sealing.

The stroke course HV is configured as a continuously differentiable function but can theoretically also comprise kinks.

The stroke course can comprise areas without gradient in the end positions, for example, as shown in FIG. 3. A reversal of the direction of inclination shortly before the end positions is also possible. In this way, a latching function can be realised in the contour of the groove 78 of the coupling element 34 without an additional component. The latching function enables the desired position to be held securely even without power supply to the actuator and despite external influences (e.g. such as accelerations) acting on the switch valve 10.

Since the devices and methods described in detail above are examples of embodiments, they can be modified to a wide extent by the skilled person in the usual manner without departing from the scope of the invention. In particular, the mechanical arrangements and the proportions of the individual elements with respect to each other are merely exemplary. Some preferred embodiments of the apparatus according to the invention have been disclosed above. The invention is not limited to the solutions explained above, but the innovative solutions can be applied in different ways within the limits set out by the claims.

1. A switch valve, comprising:
a stepping motor comprising a motor shaft;
a housing configured to receive the stepping motor;
a coupling element; and
a stroke course; and
wherein the stepping motor is operatively connected to an actuating element;
wherein the actuating element is configured to position a valve body;
wherein the valve body is configured to change the chamber volume of an air spring and is arranged in the housing so as to perform a translatory movement;
wherein the coupling element is arranged between the stepping motor and the actuating element
and is configured to convert a rotational movement of the stepping motor into a translational movement of the actuating element;
wherein the motor shaft is arranged coaxially with the actuating element and the coupling element, and
wherein the stroke course is configured in dependence on a rotational angle of the coupling element.

2. The switch valve according to claim 1, wherein the coupling element is configured to force-guide the actuating element.

3. The switch valve according to claim 2, wherein the coupling element comprises a groove configured to guide the actuating element.

4. (canceled)

5. The switch valve according to claim 1, wherein
the actuating element comprises an anti-rotation device.

6. The switch valve according claim 1, wherein the actuating element is borne in the housing so as to be axially displaceable by means of a bearing element.

7. The switch valve according to claim 1, wherein the stroke course is configured to be freely selectable as in dependence on an angle of rotation of the coupling element.

8. The switch valve according to claim 1, wherein the stroke course in the end positions of the stroke comprises a reversal of the direction of inclination.

9. The switch valve according claim 1, wherein the coupling element comprises an entry groove configured to open into the groove.

10. The switch valve according to claim 1, wherein the motor shaft and the actuating element are configured to engage in the coupling element.

11. The switch valve according to claim 1, wherein the valve body is formed coaxially with the actuating element.

12. An air spring, comprising:
a switch valve, comprising a stepping motor comprising a motor shaft, a housing configured to receive the stepping motor, a coupling element, and a stroke course;
wherein the stepping motor is operatively connected to an actuating element;
wherein the actuating element is configured to position a valve body;
wherein the valve body is configured to change the chamber volume of an air spring and is arranged in the housing so as to perform a translatory movement;
wherein the coupling element is arranged between the stepping motor and the actuating element and is configured to convert a rotational movement of the stepping motor into a translational movement of the actuating element;
wherein the motor shaft is arranged coaxially with the actuating element and the coupling element, and
wherein the stroke course is configured in dependence on a rotational angle of the coupling element.
